(19) United States
(12) Patent Application Publication
(10) Pub. No.: US 2017/0198648 A1
(43) Pub. Date: Jul. 13, 2017

(54) SYSTEM AND METHOD FOR CONTROLLING AN OPERATING MODE OF A MOTOR-GENERATOR

(71) Applicant: David E. James, Leslie, MI (US)

(72) Inventor: David E. James, Leslie, MI (US)

(21) Appl. No.: 14/991,451

(22) Filed: Jan. 8, 2016

(51) Int. Cl. F02D 29/06; H02K 7/116; F02D 25/00; F02B 63/04; F02B 61/04

(52) U.S. Cl. CPC F02D 29/06; F02B 63/04; F02B 61/04; F02D 25/00; H02K 7/116

(57) ABSTRACT

An engine system includes a first motor-generator that generates electricity in a first mode and drives a first output shaft in a second mode and a first engine that is coupled to the first motor-generator and drives the first motor-generator in the first mode to generate electricity. The engine system also includes a second motor-generator that generates electricity in a first mode and drives a second output shaft in a second mode and a second engine that is coupled to the second motor-generator and drives the second motor-generator in the first mode to generate electricity. A control module changes the mode of operation of at least one of the first motor-generator and the second motor-generator from the first mode to the second mode based on a state of at least one of the first engine and the second engine.

### FIELD

The present disclosure relates generally to an engine system and more particularly to systems and methods for controlling an operating mode of a motor-generator of an engine system based on a speed of an engine.

### BACKGROUND

This section provides background information related to the present disclosure and is not necessarily prior art.

A multi-rotor aerial transportation vehicle or mobile platform, such as an airplane, a helicopter, or a tilt-rotor aircraft, for example, may include two or more engines. Each engine may drive a specific rotor (e.g., a propeller). In some situations, one or more of the engines and/or rotors may experience a loss of power or other failure. Upon a loss of power to one or more of the engines and/or rotors, a power transmission system may transmit power to the failed engine(s) and/or rotor(s) from one or more of the remaining engines in order to allow for the continued flight of the aerial transportation vehicle. For example, some aerial transportation vehicles may include a first engine driving a first driveshaft and a first rotor and a second engine driving a second driveshaft and a second rotor. A power transmission system may include a gear system that transmits power from the first engine to the second rotor and/or from the second engine to the first rotor. Such power transmission systems often utilize a complex segmented driveshaft that couples the first driveshaft to the second driveshaft through the gearbox.

### SUMMARY

This section provides a general summary of the disclosure, and is not a comprehensive disclosure of its full scope or all of its features.

An engine system includes a first motor-generator that generates electricity in a first mode of operation and drives a first output shaft in a second mode of operation and a first engine that is coupled to the first motor-generator and drives the first motor-generator in the first mode of operation to generate electricity. The engine system also includes a second motor-generator that generates electricity in a first mode of operation and drives a second output shaft in a second mode of operation and a second engine that is coupled to the second motor-generator and drives the second motor-generator in the first mode of operation to generate electricity. A control module changes the mode of operation of at least one of the first motor-generator and the second motor-generator from the first mode of operation to the second mode of operation based on a state of at least one of the first engine and the second engine.

In one configuration, the control module changes the mode of operation of at least one of the first motor-generator and the second motor-generator based on a speed of at least one of the first engine and the second engine.

A first sensor may be associated with the first engine and a second sensor may be associated with the second engine, whereby the first sensor and the second sensor are in communication with the control module. The first sensor and the second sensor may detect an output of the first engine and the second engine, respectively. The output of the first engine may be a speed of the first engine and the output of the second engine may be a speed of the second engine. The control module may change the mode of operation of the at least one of the first motor-generator and the second motor-generator when the output of either the first engine or the output of the second engine falls below a predetermined threshold.

In one configuration, the first output shaft and the second output shaft are respectively coupled to, and drive, a propeller of a mobile platform.

A method is provided and includes generating electricity by a first motor-generator in a first mode of operation and driving a first output shaft by the first motor-generator in a second mode of operation. The first motor-generator is driven by a first engine in the first mode of operation to generate electricity. The method also includes generating electricity by a second motor-generator in a first mode of operation and driving a second output shaft by the second motor-generator in a second mode of operation. The second motor-generator is driven by a second engine in the first mode of operation to generate electricity. The method also includes changing the mode of operation of at least one of the first motor-generator and the second motor-generator from the first mode of operation to the second mode of operation based on a state of at least one of the first engine and the second engine.

In one configuration, changing the mode of operation of at least one of the first motor-generator and the second motor-generator is based on a speed of at least one of the first engine and the second engine.

In one configuration, the method includes associating a first sensor with the first engine and associating a second sensor with the second engine. The method may also include detecting an output of the first engine by the first sensor and detecting an output of the second engine by the second sensor. Detecting the output of the first engine may include detecting a speed of the first engine and detecting the output of the second engine may include detecting a speed of the second engine.

Changing the mode of operation of the at least one of the first motor-generator and the second motor-generator may include changing the mode of operation when the output of either the first engine or the output of the second engine falls below a predetermined threshold.

In one configuration, the method includes respectively coupling the first output shaft and the second output shaft to a propeller of a mobile platform.

A method is provided and includes generating electricity by a first motor-generator in a first mode of operation and driving a first output shaft by the first motor-generator in a second mode of operation. The first motor-generator is driven by a first engine in the first mode of operation to generate electricity. The method also includes generating electricity by a second motor-generator in a first mode of operation and driving a second output shaft by the second motor-generator in a second mode of operation. The second motor-generator is driven by a second engine in the first mode of operation to generate electricity. The method also includes providing electricity from one of the first motor-generator and the second motor-generator to the other of the first motor-generator and the second motor-generator to operate the other of the first motor-generator and the second motor-generator in the second mode of operation.

In one configuration, changing the mode of operation of at least one of the first motor-generator and the second motor-generator is based on a speed of at least one of the first engine and the second engine.

In one configuration, the method includes associating a first sensor with the first engine and associating a second sensor with the second engine. The method may also include detecting an output of the first engine by the first sensor and detecting an output of the second engine by the second sensor. Detecting the output of the first engine may include detecting a speed of the first engine and detecting the output of the second engine may include detecting a speed of the second engine.

Changing the mode of operation of the at least one of the first motor-generator and the second motor-generator may include changing the mode of operation when the output of either the first engine or the output of the second engine falls below a predetermined threshold.

In one configuration, the method includes respectively coupling the first output shaft and the second output shaft to a propeller of a mobile platform.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a schematic diagram of a mobile platform having an example engine system according to the present disclosure;

FIG. 2 is a schematic diagram of the engine system of FIG. 1;

FIG. 3 is a functional block diagram of an example power control system according to the present disclosure; and

FIG. 4 is a flowchart illustrating an example power control method according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

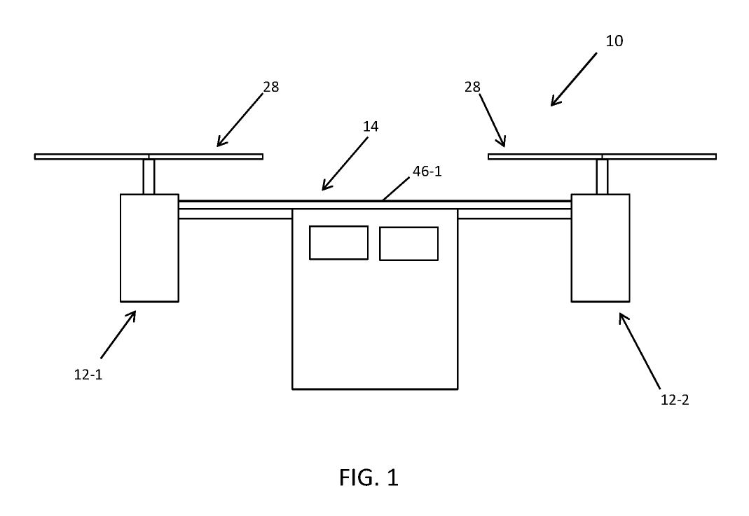

With reference to FIG. 1, multi-engine mobile platform 10 is provided. While the mobile platform 10 is shown and described herein as being a helicopter, it will be appreciated that the mobile platform may be any variety of multi-engine mobile platform, such as an airplane or a boat, for example, within the scope of the present disclosure.

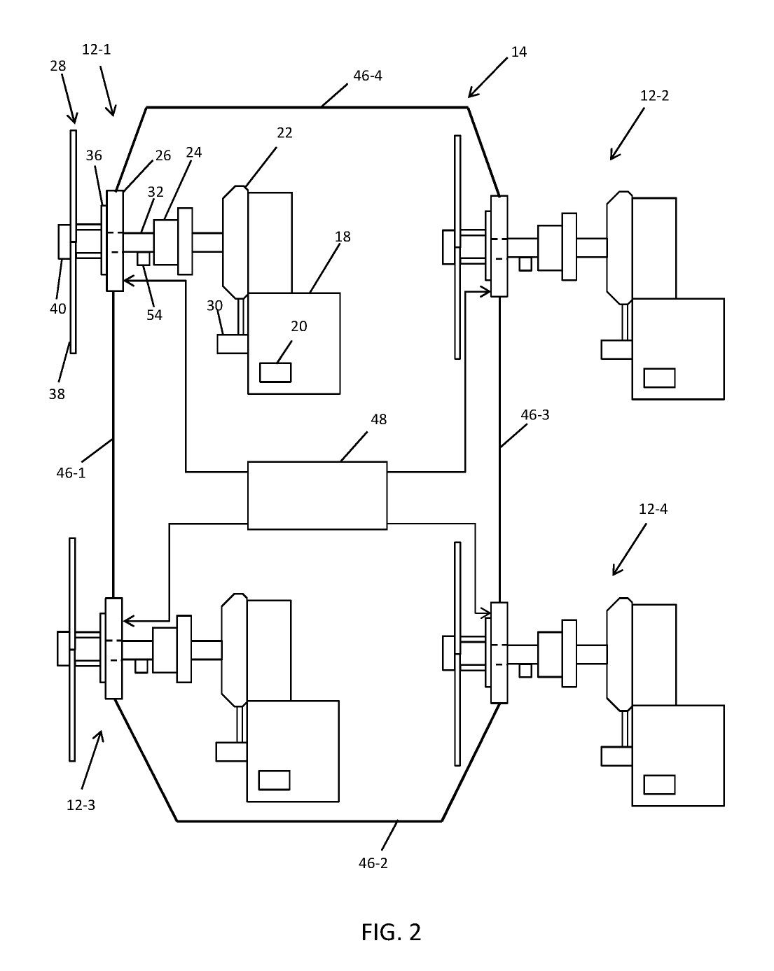

As illustrated in FIGS. 1 and 2, the mobile platform 10 may include one or more engine systems 12-1, 12-2, . . . 12-n and a power control system 14. While the mobile platform 10 is shown and described herein as including four engine systems 12-1, 12-2, 12-3, 12-4, it will be appreciated that the mobile platform 10 may include more or less than four engine systems 12 within the scope of the present disclosure.

Except as otherwise provided herein, each engine system 12 may be substantially similar to the other engine systems 12. Accordingly, except as otherwise shown or described, references herein to the engine system 12 will be understood to apply equally to each of the one or more engine systems 12-1, 12-2, . . . 12-n.

With reference to FIG. 2, each engine system 12 may include an engine 18, a governor 20, a reduction drive assembly 22, a clutch assembly 24, a motor-generator 26, and a propeller assembly 28. The engine 18 may include various configurations of an internal combustion engine, such as a spark-ignition engine or a compression-ignition engine. In this regard, the engine 18 may combust a fuel (not shown) in order to rotatably drive an output shaft 30. The governor 20 may be coupled to and/or otherwise be in communication with the engine 18 to control an output speed of the output shaft 30.

The reduction drive assembly 22 may be driven by the engine 18. For example, the reduction drive assembly 22 may include one or more gears (not shown) coupled to, and rotatably driven by, the output shaft 30. Accordingly, an input rotation of the output shaft 30 may create an output rotation of the reduction drive assembly 22.

The clutch assembly 24 may include a one-way clutch (e.g., a sprag clutch) rotatably driven by the reduction drive assembly 22. In this regard, an input rotation from the reduction drive assembly 22 may create an output rotation of the clutch assembly 24.

The motor-generator 26 may include an electric (e.g., alternating current or direct current) drive motor-generator having a driveshaft 32. As will be explained in more detail below, in a first mode of operation (e.g., a generator mode), the motor-generator 26, including the driveshaft 32, may be rotatably driven by the clutch assembly 24. In the generator mode of operation, an input rotation from the clutch assembly 24 may create an output rotation of the driveshaft 32. In this regard, in the generator mode of operation, the motor-generator 26 may generate electricity as an electrical generator. In a second mode of operation (e.g., a motor mode), the motor-generator 26, including the driveshaft 32, may be rotatably driven by the power transmission system 14. In the motor mode of operation, the power transmission system 14 may create an output rotation of the driveshaft 32. In this regard, in the motor mode of operation, the motor-generator 26 may utilize electricity as an electric motor.

The propeller assembly 28 may include a propeller flange 36, a rotor or propeller 38, and a pitch control device 40. The propeller flange 36 may be coupled to the driveshaft 32 of the motor-generator 26 such that rotation of the driveshaft 32 causes rotation of the propeller flange 36. The propeller flange 36 may, in turn, be coupled to the propeller 38, such that rotation of the propeller flange 36 causes rotation of the propeller 38. Rotation of the propeller 38 causes the mobile platform 10 to move in a manner known to those of skill in the art. The pitch control device 40 may be supported by one or both of the propeller 38 and the propeller flange 36 such that adjustment of the pitch control device 40 changes a pitch of the propeller 38. For example, the propeller pitch control device 40 may include a motor, a hydraulic actuator, and/or another mechanical actuator or system. In this regard, rotating the pitch control device 40 (e.g., a motor) can change a direction in which the mobile platform 10 moves upon rotation of the propeller 38.

The power control system 14 may include one or more wires 46-1, 46-2, . . . 46-n and a power control module 48. While the mobile platform 10 is shown and described herein as including four wires 46-1, 46-2, 46-3, 46-4, it will be appreciated that the mobile platform 10 may include more or less than four wires 46 within the scope of the present disclosure. Except as otherwise provided herein, each wire 46 may be substantially similar to the others of the wires 46. Accordingly, except as otherwise shown or described, references herein to the wire 46 will be understood to apply equally to each of the one or more wires 46-1, 46-2, . . . 46-n.

Each wire 46 may extend from one or more of the engine systems 12-1, 12-2, . . . 12-n to another one or more of the engine systems 12-1, 12-2, . . . 12-n. In particular, each wire 46 may extend from a motor-generator 26 of an engine system 12 to a motor-generator 26 of one or more other engine systems 12. As illustrated, in some configurations the motor-generator 26 of an engine system 12 may be arranged in series with the motor-generator 26 of another engine system 12. In this regard, the first wire 46-1 may extend from the motor-generator 26 of the first engine system 12-1 to the motor-generator 26 of the second engine system 12-2. The second wire 46-2 may extend from the motor-generator 26 of the second engine system 12-2 to the motor-generator 26 of the third engine system 12-3. The third wire 46-3 may extend from the motor-generator 26 of the third engine system 12-3 to the motor-generator 26 of the fourth engine system 12-4. The fourth wire 46-4 may extend from the motor-generator 26 of the fourth engine system 12-4 to the motor-generator 26 of the first engine system 12-1.

In some configurations, each motor-generator 26 may synchronize and adjust its demand for power in order to maintain a constant angular velocity across the motor-generators 26 of the various engine systems 12. In this regard, a frequency of the electrical current (e.g., alternating current) drawn by each motor-generator 26 may be proportional to the angular velocity of each motor-generator 26. In particular, the frequency of the current drawn by the motor-generator(s) 26 operating in the electric motor mode of operation may be directly proportional to the angular velocity of the motor-generator(s) 26 operating in the electrical generator mode of operation. Accordingly, when the motor-generator 26 of the first engine system 12-1 operating in the electrical generator mode is wired in series with a motor-generator 26 of one or more other engine system(s) 12 operating in the electric motor mode, power transfer from the first engine system 12-1 to the engine system(s) 12-n can occur instantaneously and without any outside control in order to maintain a constant angular velocity

In other configurations, the power control module 48 may communicate with and/or through the engine systems 12 to control the operation of the motor-generators 26. For example, in response to a change in the operation of an engine 18, including a change in the output speed of the output shaft 30, the power control module 48 may communicate with, and/or change the operating mode of, one or more of the motor-generators 26. In particular, in response to a failure of the engine 18 of the first engine system 12-1, the power control module 48 may change the operating mode of the motor-generator 26 of the first engine system 12-1 to the electric motor mode, and may change the operating mode of the motor-generator(s) 26 of one or more of the other engine systems 12 to the electrical generator mode. In this regard, the motor-generator(s) 26 operating in the electrical generator mode may provide power through the wire(s) 46 to the motor-generator(s) 26 operating in the electric motor mode, such that the motor-generator(s) 26 operating in the electric motor mode causes the rotation of the corresponding propeller(s) 38. Accordingly, upon a failure of the engine 18 of the first engine system 12-1, the motor-generator(s) 26 of one or more of the engine systems 12-2, 12-3, . . . 12-n can provide electrical power to the motor-generator 26 of the first engine system 12-1 to ensure the continued rotation of the propeller 38 of the first engine system 12-1.

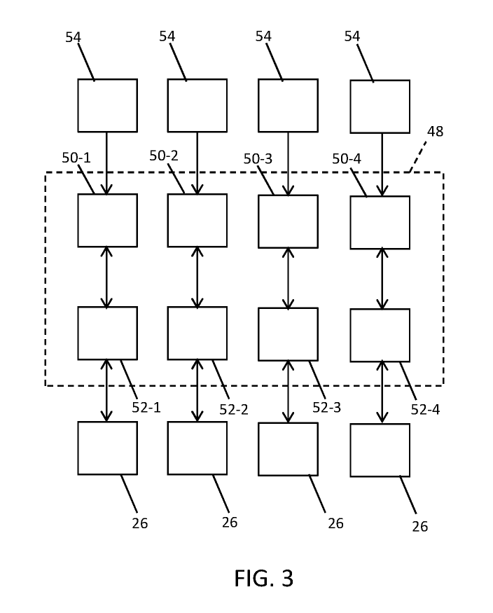

With reference to FIG. 3, an example implementation of the power control module (PCM) 48 is shown. The PCM 48 may include one or more engine speed modules 50-1, 50-2, . . . 50-n and one or more motor-generator mode modules 52-1, 52-2, . . . 52-n. While the PCM 48 is shown and described herein as including four engine speed modules 50-1, 50-2, 50-3, 50-4 and four motor-generator mode modules 52-1, 52-2, 52-3, 52-4, it will be appreciated that the mobile platform 10 may include more or less than four engine speed modules 50 and more or less than four motor-generator mode modules 52 within the scope of the present disclosure. Except as otherwise provided herein, each engine speed module 50 may be substantially similar to the others of the engine speed modules 50 and each motor-generator mode module 52 may be substantially similar to the others of the motor-generator mode modules 52. Accordingly, except as otherwise shown or described, references herein to the engine speed module 50 will be understood to apply equally to each of the one or more engine speed modules 50-1, 50-2, . . . 50-n, and, references herein to the motor-generator mode module 52 will be understood to apply equally to each of the one or more motor-generator mode modules 52-1, 52-2, . . . 52-n.

The engine speed module 50 may determine the speed of the engine 18. For example, the engine speed module 50-1, 50-2, . . . 50-n may determine the speed of the engine 18 of the corresponding engine system 12-1, 12-2, . . . 12-n. In this regard, each engine 18 may include a position sensor 54 that measures an angular position and/or angular velocity of the corresponding driveshaft 32. The position sensor 54 may communicate the angular position and/or velocity of the corresponding driveshaft 32 to the engine speed module 50. The engine speed module 50 may determine the engine speed of the engine 18 based on the angular position and/or velocity of the corresponding driveshaft 32. The engine speed module 50 may send the engine speed of the engine 18 to the motor-generator mode module 52.

The motor-generator mode module 52 may control the mode of the motor-generator 26. In particular, the motor-generator mode module 52-1, 52-2, . . . 52-n may control whether the mode of the motor-generator 26 in the respective engine system 12-1, 12-2, . . . 12-n is in the electric motor mode or the electrical generator mode. For example, the motor-generator mode module 52 may control the mode of the corresponding motor-generator 26 based on the difference between the engine speed of the corresponding engine 18 and a predetermined engine speed value. In some configurations, the motor-generator mode module 52-1, 52-2, . . . 52-n may compare the speed of the engine 18 of the corresponding engine system 12-1, 12-2, . . . 12-n to the predetermined value. In some implementations, the predetermined value may be zero. In some implementations, the predetermined value may be equal to an average engine speed of one or more of the engines 18 in the engine systems 12-1, 12-2, . . . 12-n. Accordingly, in some configurations the engine speed module 50-1 may compare the engine speed of the engine 18 in the engine system 12-1 to the average engine speed of the engines 18 in the engine systems 12-2, 12-3, . . . 12-n. If the engine speed of the engine 18 is equal to the predetermined engine speed value, the motor-generator mode module 52 may control the corresponding motor-generator 26 to operate in the electrical generator mode. If the engine speed of the engine 18 is less than the predetermined engine speed value, the motor-generator mode module 52 may control the corresponding motor-generator 26 to operate in the electric motor mode.

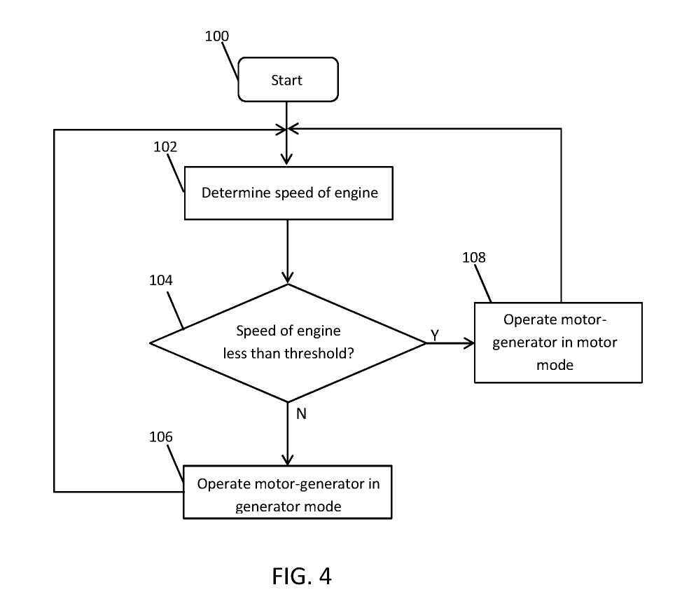

With reference to FIG. 4, a method for controlling the operation of a motor-generator based on the engine speed of an engine begins at 100. At 102, the method determines the speed of an engine. For example, at 102 the method may determine the speed of the engines 18 in each engine system 12-1, 12-2, . . . 12-n. The method may determine the speed of the engines 18 based on the position of the output shaft 30 from the position sensor 54. In particular, at 102 the engine speed module 50-1, 50-2, . . . 50-n may determine the speed of the engine 18 of the corresponding engine system 12-1, 12-2, . . . 12-n based on the position of the corresponding output shaft 30.

At 104, the method determines whether the engine speed of each engine 18 is equal to a threshold engine speed. In some configurations, the threshold engine speed may be a predetermined threshold engine speed. If the engine speed of a respective engine 18 is greater than or equal to the threshold engine speed, the method continues to 106. If the engine speed of a respective engine 18 is less than the threshold engine speed, the method continues to 108.

At 106, the method controls the operating mode of the corresponding motor-generator 26. For example, if the engine speed of the engine 18 of the engine system 12-1 is greater than the threshold engine speed, the method may control the motor-generator 26 of the engine system 12-1 to operate in the electrical generator mode. In this regard, the motor-generator mode module 52 of the engine system 12-1 may control the motor-generator 26 of the engine system 12-1 to operate in the electrical generator mode.

At 108, the method controls the operating mode of the corresponding motor-generator 26. For example, if the engine speed of the engine 18 of the engine system 12-1 is less than the threshold engine speed, the method may control the motor-generator 26 of the engine system 12-1 to operate in the electric motor mode. In this regard, the motor-generator mode module 52 of the engine system 12-1 may control the motor-generator 26 of the engine system 12-1 to operate in the electric motor mode. In so doing, the motor-generator 26 exerts a force on and continues rotation of the propeller 38 associated with the particular motor-generator 26 even if the engine speed of the engine 18 is below a threshold speed.

By wiring one or more motor-generators (e.g., motor-generators 26) together in series, one or more engines (e.g., engines 18) of one or more engine systems (e.g., engine systems 12) can provide electrical power to one or more motor-generators of others of the one or more engine systems. For example, an engine of a first engine system (e.g., engine system 12-1) can provide electrical power to a motor-generator of a second engine system (e.g., engine system 12-2). Accordingly, if the engine 18 of the second engine system stops operating properly, the engine 18 of the first engine system can simultaneously provide power to a propeller 38 of the first engine system and to the motor-generator 26 of the first engine system operating in an electrical generator mode, such that the motor-generator of the first engine system can provide electrical power to the motor-generator of the second engine system operating in an electric motor mode. In this way, the engine systems can all contribute power to maintain the angular velocity of a driveshaft (e.g., driveshaft 32) and/or rotation of a propeller (e.g., propeller 38) of the engine systems, and to ensure the continued, controlled operation of the mobile platform.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An engine system comprising:
a first motor-generator operable to generate electricity in a first mode of operation and operable to drive a first output shaft in a second mode of operation;
a first engine operably coupled to the first motor-generator and operable to drive the first motor-generator in the first mode of operation to generate electricity;
a second motor-generator operable to generate electricity in a first mode of operation and operable to drive a second output shaft in a second mode of operation, the second motor-generator wired in series with the first motor-generator; and
a second engine operably coupled to the second motor-generator and operable to drive the second motor-generator in the first mode of operation to generate electricity.

2. The engine system of claim 1, further comprising a control module operable change the mode of operation of at least one of the first motor-generator and the second motor-generator from the first mode of operation to the second mode of operation based on a state of at least one of the first engine and the second engine.

3. The engine system of claim 2, wherein the control module is operable to change the mode of operation of at least one of the first motor-generator and the second motor-generator based on a speed of at least one of the first engine and the second engine.

4. The engine system of claim 2, further comprising a first sensor associated with the first engine and a second sensor associated with the second engine, the first sensor and the second sensor in communication with the control module.

5. The engine system of claim 4, wherein the first sensor and the second sensor detect an output of the first engine and the second engine, respectively.

6. The engine system of claim 5, wherein the output of the first engine is a speed of the first engine and the output of the second engine is a speed of the second engine.

7. The engine system of claim 5, wherein the control module changes the mode of operation of the at least one of the first motor-generator and the second motor-generator when the output of either the first engine or the output of the second engine falls below a predetermined threshold.

8. The engine system of claim 1, wherein the first output shaft and the second output shaft are respectively coupled to, and drive, a propeller of a mobile platform.

9. A method comprising:
generating electricity by a first motor-generator in a first mode of operation and driving a first output shaft by the first motor-generator in a second mode of operation;
driving the first motor-generator by a first engine in the first mode of operation to generate electricity;
generating electricity by a second motor-generator in a first mode of operation and driving a second output shaft by the second motor-generator in a second mode of operation;
driving the second motor-generator by a second engine in the first mode of operation to generate electricity; and
changing the mode of operation of at least one of the first motor-generator and the second motor-generator from the first mode of operation to the second mode of operation based on a state of at least one of the first engine and the second engine.

10. The method of claim 9, wherein changing the mode of operation of at least one of the first motor-generator and the second motor-generator is based on a speed of at least one of the first engine and the second engine.

11. The method of claim 9, further comprising associating a first sensor with the first engine and associating a second sensor with the second engine.

12. The method of claim 11, further comprising detecting an output of the first engine by the first sensor and detecting an output of the second engine by the second sensor.

13. The method of claim 12, wherein detecting the output of the first engine includes detecting a speed of the first engine and detecting the output of the second engine includes detecting a speed of the second engine.

14. The method of claim 12, wherein changing the mode of operation of the at least one of the first motor-generator and the second motor-generator includes changing the mode of operation when the output of either the first engine or the output of the second engine falls below a predetermined threshold.

15. The method of claim 9, further comprising respectively coupling the first output shaft and the second output shaft to a propeller of a mobile platform.

16. A method comprising:
generating electricity by a first motor-generator in a first mode of operation and driving a first output shaft by the first motor-generator in a second mode of operation;
driving the first motor-generator by a first engine in the first mode of operation to generate electricity;
generating electricity by a second motor-generator in a first mode of operation and driving a second output shaft by the second motor-generator in a second mode of operation;
driving the second motor-generator by a second engine in the first mode of operation to generate electricity; and
providing electricity from one of the first motor-generator and the second motor-generator to the other of the first motor-generator and the second motor-generator to operate the other of the first motor-generator and the second motor-generator in the second mode of operation.

17. The method of claim 16, wherein changing the mode of operation of at least one of the first motor-generator and the second motor-generator is based on a speed of at least one of the first engine and the second engine.

18. The method of claim 16, further comprising associating a first sensor with the first engine and associating a second sensor with the second engine.

19. The method of claim 18, further comprising detecting an output of the first engine by the first sensor and detecting an output of the second engine by the second sensor.

20. The method of claim 19, wherein detecting the output of the first engine includes detecting a speed of the first engine and detecting the output of the second engine includes detecting a speed of the second engine.
